(19) United States
(12) Patent Application Publication
(10) Pub. No.: US 2008/0232046 A1
(43) Pub. Date: Sep. 25, 2008

(54) Support for a Display Screen

(75) Inventor: Eric Verriere, Lyon (FR)

Correspondence Address: Womble Carlyle Sandridge & Rice, PLLC;Attn: Patent Docketing 32nd Floor, P.O. Box 7037, Atlanta, GA, 30357-0037, US

(73) Assignee: ERARD, Chavanoz (FR)

(21) Appl. No.: 11/994,479

(22) PCT Filed: Aug. 31, 2006
(86) PCT No.: PCT/EP2006/065893

§ 371 Date: May 29, 2008

(30) Foreign Application Priority Data
Sep. 2, 2005 (FR) 0509004

(51) Int. Cl. G06F 1/16

(52) U.S. Cl. 361/681

(57) ABSTRACT

A support for a flat display screen, such as the screen of a computer, a television set or similar, is disclosed. The support includes at least one base (1) designed to be attached to a wall, and a support plate (6) designed to accommodate at least one screen on the front face of the support plate (6) and hinged to the base (1) in such a manner that it pivots about at least one axis (8). The base (1) has a symmetrical section in the shape of a C or a U, whose two branches (2a, 2b), extending from its baseplate (3), respectively carry the coaxial axes of rotation (8a, 8b) of the support plate (6). The support plate (6) includes two parallel arms (7a, 7b) extending from its backplate and respectively attached to the coaxial axes of rotation (8a, 8b), and includes means (9) for driving the support plate (6) about the axes (8a, 8b), where the driving means (9) is located between the branches (2a, 2b) of the base (1) and the arms (7a, 7b) of the support plate (6).

The present invention concerns a support for a flat display screen such as the screen of a computer, a television set, or similar.

One is familiar with supports for television sets with conventional cathode-ray tubes composed of a base designed to be fixed onto a wall, and a support plate, generally inclined, equipped with a rim, and hinged about at least one axis by means of at least one arm. In particular, this type of support for a television set is frequently used in the hotel trade so as to clear space on the ground by avoiding the use of a stand to accommodate the television set. In addition, the articulation of the support plate in relation to the base of the support allows the television set to be orientated as desired.

However, this type of screen support is unsuitable for so-called flat television screens, such as television sets of the plasma or liquid crystal display (LCD) type. Moreover, this type of support necessitates the manipulation of the support plate by the customer or the guest in order to change the orientation of the screen. It will be obvious that a motor drive, to move the support plate in relation to the base, cannot be envisaged, not only for reasons of size but above all of cost, rendering such a support undesirable.

Since the emergence of flat television screens, one is also familiar with supports that allow such screens to be retracted into a false ceiling. Such a support generally has a base recessed into a false ceiling, a support plate hinged to the base about a horizontal axis and to which the screen is secured, and an electric motor coupled to transmission means, such as a rack and pinion arrangement, to drive the screen from a retracted position in which the screen is hidden in the false ceiling, the back-plate of the support plate fitting flush with the said false ceiling, to an active position in which the screen is projecting from the false ceiling at a more-or-less right angle. The deployment and retraction of the screen are effected advantageously by means of a remote control device used to control the electric motor.

This type of support has the drawback that it required substantial and costly works for the construction of a false ceiling. Moreover, in the event of failure of the electric motor for example, the user cannot handle the screen in order to orientate it as desired.

One of the aims of the invention is therefore to overcome all of these disadvantages by proposing a support for a flat screen that is of simple and compact design and that is inexpensive, allowing a user to orientate the screen as desired, either automatically and/or manually.

To this end, and in accordance with the invention, a support is proposed for a flat display screen such as the screen of a computer, a television set or similar, having at least one base designed to be attached to a wall, and a support plate designed to accommodate at least one screen on the front face of the said support plate, and hinged to the said base in such a manner that it pivots about at least one axis. The said support is notable in that the base presents a symmetrical section in the shape of a C or a U, with the two branches emerging from its baseplate carrying the axes of rotation of the support plate, with the said support plate having two parallel arms extending from its back-plate and respectively attached to the said coaxial axes of rotation, and in that it includes means for driving the support plate about the said axes, with the said driving means extending between the branches of the base and the arms of the support plate.

It can be seen that, in contrast to the supports of the prior art, such a support is of smaller size while still allowing the user to orientate the screen in any desired direction.

In a particularly advantageous manner, the driving means are designed to drive the support plate in rotation about the axes and alternatively to leave the said support plate to rotate freely about the said axes.

Thus, in the event of malfunction of the driving means, the user is able to change the orientation of the screen manually.

The said driving means preferably consist of a motor whose output shaft is equipped with a conical toothed pinion-gear element mating with a conical toothed crown-gear element located coaxially to the axis of rotation of the support plate, the said crown-gear being attached to at least one of the arms of the support plate in such a manner that, when the motor is operated, the said pinion-gear drives the crown-gear and the support plate.

The crown-gear is made from a semi-rigid material so that, when the motor is operated, the said pinion-gear drives the crown-gear and the support plate and so that, when the motor is switched off, the application of a moment to the support plate by a user resulting in deformation of the crown-gear in such a manner that the teeth of the pinion-gear are disengaged from the teeth of the crown-gear to allow the rotation of the support plate.

According to another embodiment of the support according to the invention, the said driving means consist of a motor whose output shaft is equipped with a drive wheel mating with a plate that is coaxial with the axis of rotation of the support plate, the said plate being attached to at least one of the arms of the support plate in such a manner that, when the motor is operated, the said wheel drives the plate and the support plate by friction.

In addition, the coefficient of friction of the wheel on the plate is such that, when the drive wheel is driven in rotation by the motor at a given speed, the support plate is driven in rotation and, when the support plate is driven manually below a given speed of rotation, the drive wheel remains motionless.

Other advantages and characteristics of the invention will emerge more clearly from the description that follows of an embodiment, provided by way of a non-limiting example, of the support for a display screen according to the invention with reference to the appended drawings in which:

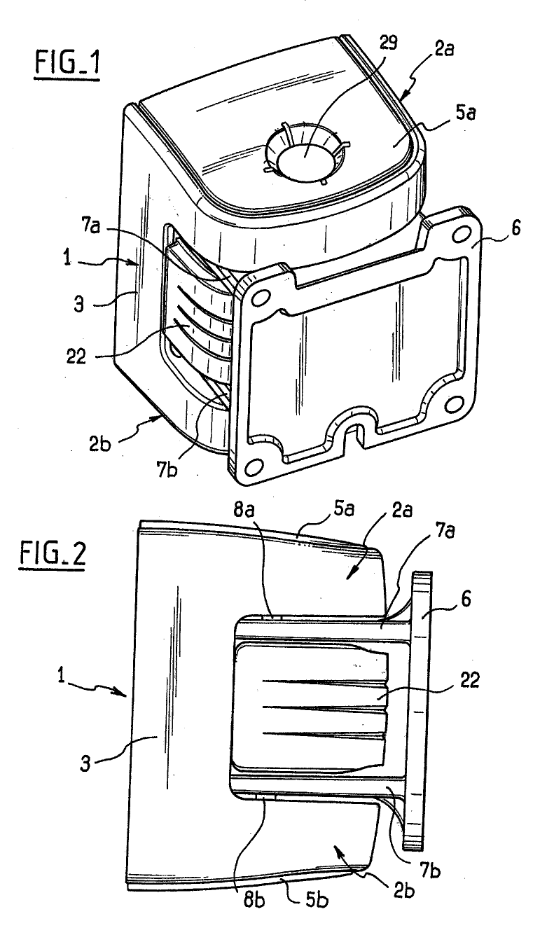

FIG. 1 is a view in perspective of the support for a display screen according to the invention,

FIG. 2 is a view from the side of the support according to the invention represented in FIG. 1,

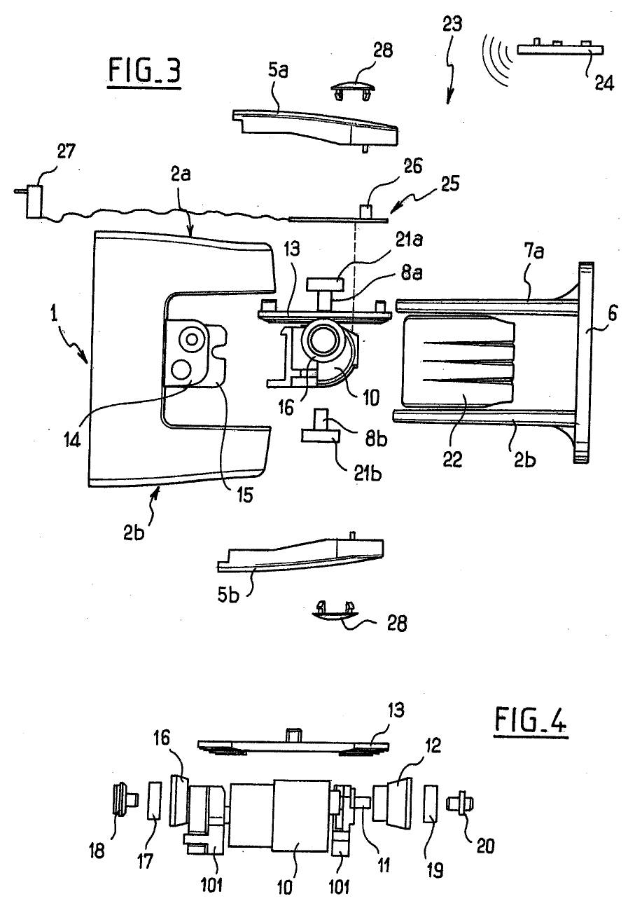

FIG. 3 is an exploded view from the side of the support according to the invention,

FIG. 4 is an exploded front view of the means for driving the support according to the invention,

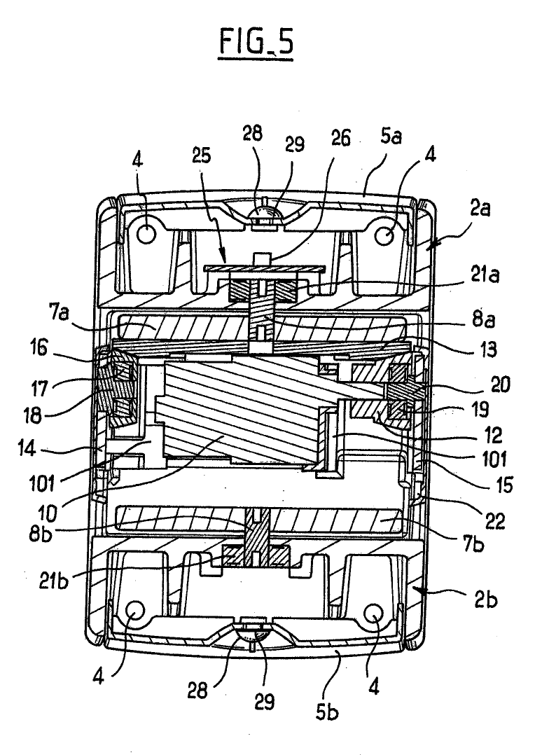

FIG. 5 is a front view in section of the support according to the invention represented in FIG. 1.

With reference to FIGS. 1, 2, 3 and 5, the support according to the invention includes a hollow base 1 of symmetrical section in the shape of a C or a U composed of two branches 2a, 2b extending from a baseplate 3. This base 1 includes fixing means (not shown in the figures) to secure the said base 1 onto a partition such as a wall for example. In this particular implementation example, the said base 1 is represented vertically so that the so-called upper branch 2a is located above the so-called lower branch 2b. With reference to FIG. 5, these fixing means consist of holes 4, two top holes and bottom holes formed respectively at the top and bottom ends of the baseplate 3, allowing the passage of screws driven into plugs inserted beforehand into the said wall. In order to provide access to the top holes 4 and the passage of the screws through the latter, the top end of the upper branch 2a is open and its edges are inclined from top to bottom and from back to front. The top end of the upper branch 2a is designed to be closed by a so-called top removable cover 5a. In like manner, the bottom end of the lower branch 2b is open, and its edges are inclined from bottom to top and back to front, with the bottom end of the lower branch 2b being designed to be closed by a so-called bottom removable cover 5b. It can be seen that the covers 5a, 5b are advantageously identical in order to limit the production costs of the support according to the invention.

In addition, the support includes a vertical support plate 6 whose front face is designed to accommodate a flat screen, such as the screen of a television set for example, and whose back-plate is equipped with two arms, an upper arm 7a and a lower arm 7b, extending perpendicularly to the said support plate 4. The distal end of the upper arm 7a includes an axle mounted to rotate freely at the end of the upper branch 2a, and the distal end of the lower arm 7b includes a second axle, located coaxially to the first axle, and mounted to rotate freely at the end of the lower branch 2b. Thus, the support plate 6 is designed to pivot about a vertical axis of rotation 8, shown by broken lines in the figures.

Referring to FIGS. 3 to 5, the support according to the invention includes driving means 9 extending between the branches 2a, 2b of the base 1 and of the arms 7a, 7b of the support plate 6.

The said driving means 9 consist of an electric motor 10 whose output shaft 11 is equipped with a so-called conical toothed drive pinion-gear element 12 mating with a conical toothed crown-gear element 13 located coaxially to the axis of rotation 8 of the support plate 6. This crown-gear 13 is attached to the upper arm 7a of the support plate 6 in such a manner that, when the electric motor 10 is operated, the said pinion-gear 12 drives the crown-gear 13 and the support plate 6 carrying the screen in rotation about the axis 8.

In a particularly advantageous manner, the crown-gear 13 is made from a semi-rigid material so that, when the motor 10 is operated, the said pinion-gear 12 drives the crown-gear 13 and the support plate 6 and so that, when the motor 10 is switched off, locks the drive pinion-gear 12 in rotation, with the application of a moment on the support plate 6 by a user resulting in deformation of the crown-gear 13 in such a manner that the teeth of the crown-gear 13 are disengaged from the teeth of the pinion-gear 12 to allow the rotation of the support plate 6.

The motor 10 is attached to the base 1 between its two branches 7a, 7b by two securing brackets 14, 15 in such a manner that the output shaft 11 of the motor 10 is located perpendicularly to the axis of rotation 8 of the support plate 6.

In addition, the support includes a second so-called bearing conical toothed pinion-gear 16, attached to the base 1, mounted to rotate freely, and mating with the toothed crown-gear 13 in such a manner that the said bearing pinion-gear 16 is engaged with the crown-gear 13 at a point which is diametrically opposite to the bearing point of the drive pinion-gear 12 on the said crown-gear 13. It will be observed that such a position of the bearing pinion-gear 16 allows the torsion of the crown-gear 13 to be limited.

In order to limit friction, and as a consequence a waste of power from the motor 10, the said bearing pinion-gear 16 is mounted on a bearing 17 carried on an axle 18 attached to the securing bracket 14 of the base 1.

In like manner, the drive pinion-gear 12 is mounted on a second bearing 19 carried on a second axle 20 attached to the securing bracket 15 of the base 1 so as to reduce friction. Moreover, each axle 8a, 8b is mounted on a bearing 21a and respectively 21b attached respectively to the branch 2a, 2b of the base 1.

In addition, the motor 10 is advantageously positioned between two damping elements 101, created from a resilient material in order to limit noise-emitting vibration.

According to an execution variant of the support according to the invention (not shown in figures), the drive pinion-gear 12 and the crown-gear 13 are replaced respectively by a smooth conical wheel and a plate with a chamfered edge. Thus, the driving means consist of a motor whose output shaft is equipped with a drive wheel mating with a plate that is coaxial with the axis of rotation 8 of the support plate 6, with the said plate being attached to at least one of the arms 7a or 7b of the support plate 6 in such a manner that, when the motor 10 is operated, the said wheel drives the plate and the support plate 6.

The coefficient of friction of the drive wheel on the plate is such that, when the said wheel is driven in rotation by the motor 10 at a given speed, the support plate 6 is driven in rotation about the axis 8 and, when the support plate 6 is driven manually below a given speed of rotation, the drive wheel remains motionless. In this implementation example, it will be observed that the said coefficient of friction will depend in particular on the weight of the screen fixed onto the support plate 6, and on the materials from which the drive wheel and the plate are made.

It is very obvious that these driving means can be replaced by other equivalent driving means designed to drive the support plate 6 in rotation about the axes 8a, 8b and alternatively to allow free rotation of the said support plate 6 about the said axes 8a, 8b.

In addition, with reference to FIG. 3, the support includes a protective casing 22 in the general shape of a U or a C, and designed to enclose the driving means 9 composed of the motor 10, the drive pinion-gear 12 and the crown-gear 13, between the branches 2a, 2b of the base 1 and the arms 7a, 7b of the support plate 6.

The free ends of the branches of the casing 22 includes fixing means coupled to additional fixing means, (not shown in the figures), attached to the base 1 in such a manner that the said casing 22 is fixed in a non-removable manner to the said base 1.

In an advantageous manner, with reference to FIG. 3, the support includes control means 23 for the driving means 9.

These control means 23 consist of a remote control 24 equipped with infrared transmission means designed to transmit control signals to an electronic card 25 equipped with the means 26 to receive the said signals, such as a LED for example. This electronic card 25 is powered by power sources 27 such as a transformer that converts the mains voltage to a level of 12V for example. In addition, the said electronic card 25 is connected to the motor 10 in order to supply it with power.

This electronic card 25 is positioned in the upper branch 2a of the base 1 in such a manner that its receiving means are located opposite to a lens 28 for converging the signals transmitted by the remote control 24. The said lens 28 consists of an element created from a plastic material of generally hemispherical shape whose convex side is oriented toward the exterior, namely upwards, and forms a circular aperture 29 created in the top cover 5a of the upper branch 2a of the base 1. Thus, the signals transmitted by the remote control 24 are reflected at the interface between the lens 28 and the air so as to converge toward the receiving means 26 on the electronic card 25.

It goes without saying that the electronic card can be positioned in the lower branch 2b of the base 1 without moving outside the scope of the invention.

In addition, it is obvious that the receiving means can be remoted on the outside of the base 1, mounted on a support of any kind, and connected to the electronic card 25 by means of a cable.

The electronic card 25 also advantageously includes a memory unit (not shown in FIG. 3), in which particular sequences can be recorded. Thus, a user will be able to pivot the screen by applying continuous pressure on a button of the remote control 24 until the desired orientation is achieved, or by applying a single press to a second button of the said remote control for the screen to move to a predetermined orientation.

It is very obvious that the transmission and reception means of the control means can consist of any suitable means without moving outside the scope of the invention.

Moreover, it goes without saying that the support can be fixed onto any wall such as the wall of a building or the wall of a furnishing structure for example.

Finally, it is very obvious that the support according to the invention will be able to accommodate flat computer screens, information screens or similar, and that the examples that have just been described are not on any way limiting of the fields of application of the invention.

1. A support for a flat display screen the support having at least one base designed to be attached to a wall, and a support plate designed to accommodate at least one screen on the front face of the support plate, and hinged to the base in such a manner that the support plate pivots about at least one axis, wherein:
the base has a symmetrical section in the shape of a C or a U, the symmetrical section including two branches extending from a baseplate and respectively carrying coaxial axes of rotation of the support plate;
the support plate includes two parallel arms extending from a back-plate and respectively attached to the coaxial axes of rotation; and
the base includes means for driving the support plate about the axes of rotation, with they driving means extending between the two branches and the two parallel arms.

2. A support according to claim 1, wherein the driving means are designed to drive the support plate in rotation about the axes, and alternatively to allow free rotation of the support plate about the axes of rotation.

3. A support according claim 1, wherein:
the driving means comprises a motor having an output shaft equipped with a conical toothed drive-gear element mating with a conical toothed crown-gear element located coaxially with respect to the axes of rotation; and
the crown-gear element is attached to at least one of the arms in such a manner that, when the motor is operated, the pinion-gear drives the crown-gear and the support plate.

4. A support according to claim 3, wherein the crown-gear element is made from a semi-rigid material so that, when the motor is operated, the drive-gear element drives the crown-gear element and the support plated and so that, when the motor is switched off, the application of a moment onto the support plate by a user results in deformation of the crown-gear element in such a manner that teeth of the crown-gear element are disengaged from teeth of the drive-gear element so as to allow rotation of the support plate about the axes of rotation.

5. A support according to claim 3, wherein the motor is attached to the base between the two branches in such a manner that the output shaft is located perpendicularly to the axes of rotation.

6. A support according to claim 3, wherein the support includes a bearing conical toothed pinion-gear attached to the base and mating with the conical toothed crown-gear element in such a manner that the bearing pinion-gear is engaged with the crown-gear element at a point which is diametrically opposite to a bearing point of the drive-gear element on they crown-gear element.

7. A support according to claim 6, wherein the bearing conical toothed pinion-gear is mounted on a bearing attached to the base.

8. A support according to claim 3, wherein the drive-gear element is mounted on a second bearing attached to the base.

9. A support according to claim 1, wherein:
the driving means comprises a motor including an output shaft equipped with a drive wheel mating with a plate that is coaxial with the axes of rotation; and
the plate that is coaxial with the axes of rotation is attached to at least one of the arms in such a manner that, when the motor is operated, the wheel drives the support plate and the plate that is coaxial with the axes of rotation.

10. A support according to claim 9, wherein the coefficient of friction of the drive wheel on the plate that is coaxial with the axes of rotation is such that, when the wheel is driven in rotation by the motor at a given speed, the support plate is driven in rotation and, when the support plate is driven manually below a given speed of rotation, the drive wheel remains motionless.

11. A support according to claim 3, wherein the support includes a protective casing in the general shape of a U or a C, wherein the protective casing is designed to enclose the motor, the drive-gear element and the crown-gear element between the two branches the two arms.

12. A support according to claim 11, wherein free ends of branches of the casing include fixing means coupled to additional fixing means attached to the base in such a manner that the casing is fixed in a non-removable manner to the base.

13. A support according to claim 3, wherein the support includes means to control the driving means.

14. A support according to claim 13, wherein the control means comprise a remote control equipped with transmission means designed to transmit control signals to an electronic cards equipped with means to receive the control signals, wherein the electronic card is connected to the motor.

15. A support according to claim 14, wherein:
the electronic card is positioned in one of the two branches that is an upper branch or lower branch of the base in such a manner that the means to receive the control signals are located opposite to a convergent lens for the control signals; and
the convergent lens is fitted in a circular aperture in a top cover or bottom cover of the upper or lower branch.

16. A support according to claim 15, the convergent lens comprises an element created from a plastic material of generally hemispherical shape and having a convex side oriented toward the exterior, namely upwards or downwards respectively.

17. A support according to claim 9, wherein the support includes a protective casing in the general shape of a U or a C, wherein the protective casing is designed to enclose the motor, the drive wheel and the plate that is coaxial with the axes of rotation between the two branches.

18. A support according to claim 17, wherein free ends of branches of the casing include fixing means coupled to additional fixing means attached to the base-in such a manner that the casing is fixed in a non-removable manner to the base.

19. A support according to claim 9, wherein the support includes means to control the driving means.

20. A support according to claim 19, wherein the control means comprise a remote control equipped with transmission means designed to transmit control signals to an electronic card equipped with means to receive the control signals, wherein the electronic card is connected to the motor.
